(19) United States
(12) Patent Application Publication
(10) Pub. No.: US 2023/0399130 A1
(43) Pub. Date: Dec. 14, 2023

(54) Localizing Underwater Robots from the Air

(71) Applicant: Trustees of Dartmouth College, Hanover, NH (US)

(72) Inventors: Charles J. Carver, Lebanon, NH (US); Qijia Shao, West Lebanon, NH (US); Alberto Quattrini Li, Lebanon, NH (US); Xia Zhou, Hanover, NH (US)

(21) Appl. No.: 18/209,941

(22) Filed: Jun. 14, 2023

Related U.S. Application Data
(60) Provisional application No. 63/352,220, filed on Jun. 14, 2022.

(51) Int. Cl. B64U 20/83; B63B 35/00

(52) U.S. Cl. CPC B64U 20/83; B63B 35/00; B63B 2035/008; B64U 2201/10

(57) ABSTRACT

A system includes an aerial drone with a queen component disposed thereon and an underwater robot with a worker component disposed thereon. The queen component is in electrical communication with the aerial drone and the worker component is in electrical communication with the underwater robot. The queen component is configured to steer a laser beam to locate and track the worker component and to sense light from the laser beam reflected by the worker component. A method includes deploying an aerial drone with a queen component disposed thereon in a first medium and determining a location of a robot in a second medium with a worker component disposed thereon using the aerial drone. The second medium is different from the first medium.

### CROSS REFERENCE TO RELATED APPLICATIONS

This application claims priority to U.S. Provisional Application No. 63/352,220, filed on Jun. 14, 2022, the disclosure of which is incorporated herein by reference.

### STATEMENT REGARDING FEDERALLY SPONSORED RESEARCH

This invention was made with government support under contracts CNS-1955180 and MRI-1919647 awarded by the National Science Foundation. The government has certain rights in the invention.

### FIELD OF THE DISCLOSURE

This disclosure relates to a system configured to determine a position of a robot using a drone, and a method of doing the same.

### BACKGROUND OF THE DISCLOSURE

Underwater robots/sensors play a critical role in advancing explorations and monitoring of the underwater world. High impact applications include inspection of aging national infrastructure and prevention of water pollution. To enable such applications and to scale up the use of underwater assets, it is important to obtain their global location during deployment. However, unlike land technology, there is no underwater global localization infrastructure. Instead, most of the technology focuses on dead reckoning through inertial or acoustic sensors.

For global sensing of underwater assets, the mainstream method relies on an infrastructure (e.g., a boat, a network of buoys) temporarily deployed on the water's surface. The infrastructure is connected to both underwater assets (via acoustic transducers, completely in the water) and the ground station (via tethering or Wi-Fi). The logistical and deployment overhead of these surface buoys or vehicles constrains sensing coverage, resulting in limited scalability. Additionally, since floating surface buoys follow the current, they offer limited mobility for proactive control. Therefore, it is generally recognized that using flying vehicles with a bird's eye view to directly sense underwater assets will advance such efforts. Not only do flying vehicles expand the sensing coverage, but they also offer greater control over mobility and deployability. To realize this goal, it is essential to allow aerial drones to directly sense underwater nodes without surface relays.

Existing technologies for wireless sensing only consider a single physical medium and are, thus, inapplicable in the air-water setting. For example, sensing with radio frequency (RF) signals has shown the appealing capability of motion tracking in the air, but these same RF signals would suffer severe attenuation in the water and could not sustain reasonable sensing distances. Additionally, although acoustic sensing is the mainstream method for sensing underwater robots, these acoustic signals cannot cross the air-water boundary and, thus, preclude direct air-water sensing.

It can be difficult to detect a position of an underwater robot without using devices on the surface of the wafer. Improved techniques and systems are needed.

### SUMMARY OF THE DISCLOSURE

The present disclosure provides a system and a method to detect a position of an underwater robot that is capable of wirelessly sensing across the air-water interface, eliminating the need for additional infrastructure.

An embodiment of the disclosure includes a laser-based sensing system to enable aerial drones to directly locate underwater robots. The system may consist of a queen component and a worker component on a drone and an underwater robot, respectively.

According to an embodiment of the present disclosure, the system may further include a pinhole-based sensing mechanism to address the sensing skew at air-water boundary and determine the incident angle on the worker component, an optical-fiber sensing ring to sense weak retroreflected light, a laser-optimized backscatter communication design that exploits laser polarization to maximize retroreflected energy, and the necessary models and algorithms for underwater sensing.

As demonstrated in Example 1, in an embodiment of the present disclosure, the system and method disclosed may achieve an average localization error of 9.7 cm with ranges up to 3.8 m and may be robust against ambient light interference and wave conditions.

Further, the present disclosure provides a system having an aerial drone with a queen component disposed thereon and an underwater robot with a worker component disposed thereon. The queen component may be in electrical communication with the aerial drone, and the worker component may be in electrical communication with the underwater robot. The queen component may be configured to steer a laser beam to locate and track the worker component, and may be configured to sense light from the laser beam reflected by the worker component.

According to an embodiment of the present disclosure, the queen component may include a laser steering component and a sensing component.

According to an embodiment of the present disclosure, the worker component may include an angle-of-arrival sensing component and a retroreflective tag.

According to an embodiment of the present disclosure, a scan point of the laser beam may be delayed thereby enabling the laser beam to hit a plurality of underwater positions for a single outgoing angle.

According to an embodiment of the present disclosure, the system may further include a pinhole-based sensing mechanism.

According to an embodiment of the present disclosure, the system may further include an optical fiber sensing ring.

According to an embodiment of the present disclosure, the system may further include a backscatter communication design configured to maximize retroreflected energy.

According to an embodiment of the present disclosure, the queen component may be configured to determine a position of the underwater robot in water using the aerial drone in air.

According to an embodiment of the present disclosure, queen component may determine a position of the underwater robot using a GPS location and altitude sensor reading of the aerial drone.

According to an embodiment of the present disclosure, the laser may be a blue/green laser.

Even further, the present disclosure provides a method including deploying an aerial drone with a queen component disposed thereon in a first medium, and determining a location of a robot in a second medium with a worker component disposed thereon, using the aerial drone. The second medium may be different from the first medium.

According to an embodiment of the present disclosure, the first medium may be air and the second medium may be water.

According to an embodiment of the present disclosure, the queen component may be configured to steer a laser beam to locate and track the worker component.

According to an embodiment of the present disclosure, the queen component may be further configured to sense light from the laser beam reflected by the worker component.

According to an embodiment of the present disclosure, the worker component may include a retroreflective tag.

According to an embodiment of the present disclosure, a scan point of the laser beam may be delayed thereby enabling the laser beam to hit a plurality of positions in the second medium for a single outgoing angle.

According to an embodiment of the present disclosure, the laser may be a blue/green laser.

According to an embodiment of the present disclosure, the laser may have a wavelength range configured to minimize attenuation in the first medium and the second medium.

According to an embodiment of the present disclosure, the determining may further include sensing an incident angle of the worker component, sending angle-of-arrival data and depth data of the worker component from the worker component to the queen component via backscatter communication, and determining a location of the worker component in real time using the angle-of-arrival data, the depth data, a GPS location of the queen component, and altitude of the queen component.

According to an embodiment of the present disclosure, a non-transitory computer readable medium storing a program may be configured to instruct a processor to execute determining a location of the object using the aerial drone.

### BRIEF DESCRIPTION OF THE FIGURES

For a fuller understanding of the nature and objects of the disclosure, reference should be made to the following detailed description taken in conjunction with the accompanying figures.

FIGS. 1A-1C display schematic of an embodiment in accordance with the disclosure, including the queen component and the worker component.

FIG. 2 displays an embodiment of the optical fiber ring.

FIGS. 3A-3B display graphical data pertaining to the scanning pattern and the coverage of link acquisition as described in Example 1.

FIG. 4 displays a schematic of the Angle-of-Arrival (AoA) sensing.

FIG. 5 displays a schematic of the laser-optimized backscatter optics.

FIG. 6 displays a geometric model of localization.

FIG. 7 displays a block diagram of the circuit included in the queen component.

FIG. 8 displays a schematic of the queen component and an exploded view of backscatter sensing and beam steering.

FIGS. 9A-9B display an exploded view of the worker component and a block diagram of the circuit included in the worker component.

FIGS. 10A-10B display the experimental set up used to test an embodiment of the present disclosure.

FIGS. 11A-11B display graphical data pertaining to experimental results of an embodiment disclosed herein tested in a water tank, as described in Example 1.

FIGS. 12A-12B display graphical data pertaining to experimental results of an embodiment disclosed herein tested in a pool, as described in Example 1.

FIGS. 13A-13B display graphical data pertaining to range tests for backscatter communication and AoA sensing, as described in Example 1.

FIGS. 14A-14B display graphical data pertaining to the impact of wave conditions and ambient light, as described in Example 1.

### DETAILED DESCRIPTION OF THE DISCLOSURE

Although claimed subject matter will be described in terms of certain embodiments, other embodiments, including embodiments that do not provide all of the benefits and features set forth herein, are also within the scope of this disclosure. Various structural, logical, process step, and electronic changes may be made without departing from the scope of the disclosure. Accordingly, the scope of the disclosure is defined only by reference to the appended claims.

Ranges of values are disclosed herein. The ranges set out a lower limit value and an upper limit value. Unless otherwise stated, the ranges include all values to the magnitude of the smallest value (either lower limit value or upper limit value) and ranges between the values of the stated range.

The steps of the method described in the various embodiments and examples disclosed herein are sufficient to carry out the methods of the present disclosure. Thus, in an embodiment, the method consists essentially of a combination of the steps of the methods disclosed herein. In another embodiment, the method consists of such steps.

Embodiments disclosed herein can wirelessly locate underwater robots using an aerial drone without the need for additional infrastructure or system components on the water surface. The system can include a queen component and/or a worker component on the drone and each underwater robot to be tracked, respectively. For example, there may be a queen component on the aerial drone and a worker component on the robot. The queen component on the drone steers a laser beam to locate and track the worker component installed on each underwater robot. System elements may include (1) a pinhole-based sensing mechanism to address the sensing skew at air-water boundary, (2) an optical-fiber sensing ring to sense weak retroflected light, (3) a laser-optimized backscatter communication design that exploits laser polarization to maximize retroflected energy, and (4) models and algorithms for localization.

Embodiments disclosed herein can directly locate an object (e.g., robot) within a medium (e.g., water) different from the medium (e.g., air) where the tracker (e.g., drone) is located without needing any infrastructure support or additional system components on the air-water boundary. Existing localization technologies typically locate objects in the same medium and need infrastructure support on the water surface, which presents deployment and maintenance problems. The use of aerial drones with a bird's eye view to directly locate underwater robots expands the sensing coverage and offers greater control over mobility and deployability.

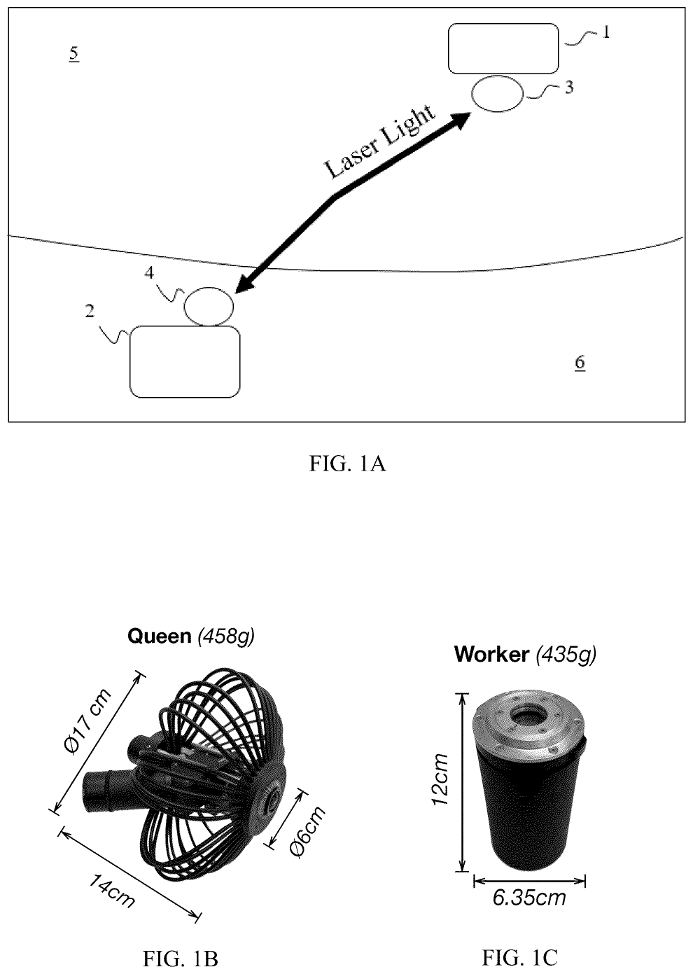

As shown in FIG. 1, an embodiment of the present disclosure includes a system having an object 2, such as a robot, or more specifically an underwater robot; a tracker 1, such as a drone, or more specifically an aerial drone; a queen component 3 in electrical communication with the tracker 1; and a worker component 4 in electrical communication with the object 2. The tracker 1 and the object 2 may operate within a first medium 5 and a second medium 6. For example, in an embodiment, the tracker 1 may operate within air, while object 2 may operate within water. Other mediums besides air and water are possible and the tracker 1 and object 2 can be configured to operate in these various mediums. Each of the tracker 1 and object 2 can be autonomous or controlled by a user. The tracker 1 and object 2 can take many forms, including drones or remotely-operated vehicles. The tracker 1 and object 2 can be designed for exploration, work, military, recreational, or other applications. In an instance, the tracker 1 can be a multi-rotor, fixed-wing, single rotor, hybrid vertical take-off and landing, or other type of drone.

An embodiment of the queen component 3, as shown in FIG. 1B, may be disposed on the tracker 1 (FIG. 1A). An embodiment of the worker component 4, as shown in FIG. 1C, may be disposed on the object 2 (FIG. 1A). The queen component 3 may be composed of a laser steering and sensing component, while the worker component 4 may contain an angle-of-arrival (AoA) sensing component and a retroreflective tag. The queen component 3 may detect the location of the worker component 4 by steering a laser beam to sense the light retroreflected by the worker component 4. Once the laser beam emitted from the queen component 3 hits the worker component 4, the worker component 4 senses its incident angle after the impact of refraction. This causes the worker component 4 to send its AoA and depth (sensed by the object's built-in-depth sensor) back to the queen component 3 through backscatter communication. The queen component 3 combines the information received by the worker component 4 with its own GPS location and altitude sensor to determine the location of the worker component 4 in real time.

In an embodiment, the queen component 3 may find the presence of the worker component 4 and establish a communication channel. By exploiting the path symmetry of light, a single transceiver can steer its laser beam until it hits the other node's retroreflector, therefore instantly detecting when the link has been established.

The present disclosure further provides a method comprising deploying the tracker 1 in a first medium 5 and determining a location of an object 2 in a second medium 6 using the tracker 1. In an embodiment, the queen component 3 may be disposed on the tracker 1, and the worker component 4 may be disposed on the object 2. The first medium may be a gas and the second medium may be a liquid, such as air and water.

The sensing range can further be extended with higher-power laser diodes. To avoid path blockage, water surface dynamics, which can refract the laser beam differently, can be leveraged to provide alternate beam paths to avoid the blockage.

In some embodiments, various steps, functions, and/or operations of the system disclosed herein and the methods disclosed herein are carried out by one or more of the following: electronic circuits, logic gates, multiplexers, programmable logic devices, ASICs, analog or digital controls/switches, microcontrollers, or computing systems. Program instructions implementing methods such as those described herein may be transmitted over or stored on carrier medium. The carrier medium may include a storage medium such as a read-only memory, a random access memory, a magnetic or optical disk, a non-volatile memory, a solid state memory, a magnetic tape, and the like. A carrier medium may include a transmission medium such as a wire, cable, or wireless transmission link. For instance, the various steps described throughout the present disclosure may be carried out by a single processor (or computer system) or, alternatively, multiple processors (or multiple computer systems). Moreover, different sub-systems of the system disclosed herein may include one or more computing or logic systems. Therefore, the above description should not be interpreted as a limitation on the present disclosure but merely an illustration.

The following example is presented to illustrate the present disclosure. It is not intended to be limiting in any matter.

### Example 1

The following in an example of direct air-water sensing using laser light, with the goal of enabling an aerial drone to locate underwater robots without any surface relays.

This example describes an embodiment of the present disclosure having an object 2, such as an underwater robot; a tracker 1, such as a drone, or more specifically an aerial drone; a queen component 3 in electrical communication with the tracker 1; and a worker component 4 in electrical communication with the object 2.

As explained in the following example, the prototype system of an embodiment of the present disclosure was tested with an aerial drone and underwater robot in a swimming pool. Results show centimeter-level localization errors when locating an underwater robot (1 m depth) from the drone (1.6 m height). As demonstrated in this example, the system is robust against ambient light interference, waves, and disturbances affecting drone station-keeping, which is a problem especially present in shallow waters. Hardware components can be configured to extend the sensing range and shorten tracking latency.

Light is a suitable medium because it can effectively pass the air-water interface with less than 10% energy reflected back (when the incident angle is <50°). Compared to acoustics, light propagates faster and entails shorter communication/sensing latency. Compared to radio frequency (RF), light endures much lower attenuation in the water. For example, light in the blue/green region (e.g., 420 nm-550 nm) attenuates less than 0.5 dB/m in water. This example considered blue/green laser light due to its superior sensing properties including (1) narrow (5-10 nm) spectral power distribution, allowing optical energy to be concentrated to the wavelength range with the smallest attenuation in the air/water, and (2) low beam divergence, which maximizes the energy efficiency and enhances communication/sensing distance.

An embodiment of the present disclosure includes a queen component on the aerial drone and a worker component on each underwater robot to be located. To sense the worker component from the air, the queen component steers a narrow laser beam and senses the light reflected by the worker component.

The retroreflection phenomenon was exploited by attaching a retroreflective tag to the worker component. A retroreflective tag reflects incoming light back to the source, easing the identification of the underwater robot's direction. Sensing based on retroreflected light also eliminates the need of any active emitter on the worker component, leading to a simplified system design. The main technical elements address numerous practical challenges in this scenario. First, a pinhole-based sensing mechanism used with the worker component to determine the incident angles of the laser beam, which resolves the difference between the incident angle on the water's surface and on the underwater worker component. Second, to sense extremely weak retroreflected light across the air-water boundary, an optical fiber sensing ring was used on the queen component to enlarge the sensing area and improve sensing sensitivity. Backscatter optics in the system were tailored to laser light, which exploit the polarization of laser light to maximize the energy of retroreflected light, and select a backscatter modulation scheme to combat ambient light interference. Third, an adaptive sensing algorithm robust to water dynamics was used.

A prototype system of an embodiment of the present disclosure was implemented and fabricated using hardware and printed circuit boards (PCBs). The system and an embodiment of the method of the present disclosure were tested in a water tank and pool. Some findings were as follows: (1) the system and method of this embodiment locates an underwater robot (1 m depth) from the air (1.6 m height) with an average error of 5.5 cm in the water tank and 9.7 cm in the pool; (2) the system and method's sensing range is dictated by the success of laser-optimized backscatter communication, which achieves 90% packet success rate up to a 3.8 m air-water distance (2.3 m air, 1.5 m water); (3) the system and method's AoA sensing accuracy is stable across the whole sensing range (−50° to 50°) with an average error of 1.2°; and (4) the system and method is robust against ambient light interference, waves, and disturbances affecting underwater autonomous vehicle (AUV) station-keeping.

Achieving accurate air-water sensing using laser light presented a number of practical challenges that were addressed in this example. One challenge was sensing skew at the boundary. The air-water context can complicate the geometry for locating underwater robots from the air because of the refraction occurring at the air-water interface. To illustrate this challenge, consider a conventional laser-based localization system in a single medium. First, a laser transmitter emits a beacon signal modulated with its position information and outgoing beam angle. Once the laser beam reaches the receiver, the transmitter's outgoing beam angle and position information can be extracted. This scheme, however, fails to work through the air-water interface since light refracts according to Snell's law, causing the incident angle on the air-water boundary to differ from the incident angle on the underwater receiver. Consequently, the underwater robot would incorrectly localize itself relative to the transmitter if it only relied on the transmitter's information.

Furthermore, assuming the refractive indices were known ahead of time and the receiver used Snell's law to compute the underwater incident angle, this would only support static air-water interfaces. In the real world, however, air-water boundaries are dynamic and composed of ever-changing waves. Hence, for a given outgoing beam angle, the refracted angle through the water's surface will change depending on the position the light hits the wave. If the receiver ignores this scenario, the computed localization will oscillate depending on the wave shape, leading to consistently incorrect localization results.

Another challenge presented was sensing extremely-weak retroreflected light. The air-water scenario weakens the retroreflected light traveling across the air-water boundary twice. Robust sensing of this extremely-weak retroreflected light is critical to maintaining a meter-level sensing range sufficient for robotics applications. As the laser light travels through the air, it undergoes free space path loss inversely proportional to its wavelength. Once the light hits the air-water interface, up to 10% of the light is reflected (as long as the incident angle is below 50°). Then, as the light travels underwater, it undergoes attenuation proportional to its wavelength (in the visible light region). Finally, once the light hits the underwater retroreflector, the retroreflective loss can be over 90% depending on the incident angle and retroreflective material. After reflecting back to the aerial transmitter, the light beam will encounter the above loss once again: underwater attenuation, up to 10% loss at the boundary, and aerial attenuation. After summing all these potential losses, the received signal strength can be buried by noise. Since gain is often inversely proportional to response time, traditional photodiodes would be unable to capture this faint amount of light. Furthermore, assuming an average level of ambient light at sea level, the received signal-to-noise ratio (SNR) could be as low as −14 dB (assuming a 100 mW, 520 nm laser diode), which can be too low to be received without additional filtering mechanisms. Additionally, these calculations all assume the backscatter receiver's photodiode is perfectly collocated with the outgoing laser beam. In reality, however, physical constraints require the receiver's photodiode to be placed with an offset relative to the outgoing beam.

Although the choice of retroreflective material can help reduce the energy loss during retroreflection, the most energy efficient options (e.g., corner-cube retroreflectors) are large and rigid, typically making them impractical for sensing applications. Flexible retroreflectors (e.g., retroreflective tape) can be seamlessly molded around various surfaces yet result in a large amount of specular and diffusive reflections. From experimentation, it was found that retroreflective tape reflects less than 40% of light compared to corner-cube retroreflectors. While feasible, this may be unfavorable when coupled with the attenuation caused by the air-water boundary.

A third challenge presented was ambient light interference. Compounding the above issues is the presence of ambient light interference. If a simple pulse detection strategy is used (i.e., triggering on the rising edge of a sensed pulse), it can be prone to false positives caused by the environment. This may be pertinent if the gain of the receiver is tuned high enough to detect the faint amount of retroreflected light. From experimentation, it was found that implementing an analog rising-edge pulse detector that was sufficiently sensitive to receive the backscattered light would falsely trigger multiple times per minute in the single-medium scenario. When coupled with water, where stray reflections are unavoidable, the false trigger rate was multiple times per second. Additionally, encoding the laser light with a unique frequency would be unsuitable for separating stray reflections from backscattered signals. This is because if the encoded laser light hits a reflective surface (e.g., water wave causing specular reflection back to the transmitter), the receiver would still detect the frequency signature despite not hitting the retroreflective target.

An embodiment of the present disclosure addresses the above challenges. To overcome the sensing skew at the boundary, instead of sensing the refraction angle, an embodiment of the present disclosure uses an AoA sensing component on the underwater robot that senses the incident angle after refraction from the current wave surface. To sense the weak retroreflected light, an optical fiber sensing ring can be used to enhance the sensing sensitivity while easing the collocation of the photodiode and transmitter. To combat ambient light interference, the spectrum sparsity of laser light can be exploited to filter out most ambient light energy.

Specifically, in this Example, an embodiment of the present disclosure includes a queen component and a worker component. The queen component resides on an aerial drone, and the worker component is collocated with the underwater robot. The queen component includes a laser steering and sensing component, while the worker component contains the AoA sensing component and a retroreflective tag. During link acquisition, the queen component actively steers a laser beam to sense the light retroreflected by the worker component, thereby identifying the robot directions. Once the queen component's laser beam hits the worker component, the worker component senses its incident angle after the impact of refraction. It then sends its AoA and depth (sensed by robot's depth sensor) back to the queen component via backscatter communication. Finally, the queen component combines this information with its own GPS location and altitude sensor, computing the worker component's location in real time.

Robust Link Acquisition

The first step in air-water sensing is for the queen component to find the presence of the worker component and establish a communication channel. By exploiting the path symmetry of light, a single transceiver can steer its laser beam until it hits the other node's retroreflector, therefore instantly detecting when the link has been established. Although this method is faster than an active approach (i.e., having two transceivers coordinate with each other), scanning a sufficiently large range for the other node can take hundreds of milliseconds. If either the aerial or underwater nodes move or the water changes the angle of refraction, the scanning phase may need to be repeated. It can be difficult to directly apply efficient free-space optics (FSO) algorithms because despite their ability to scan a large area in an efficient amount of time, these algorithms do not consider frequent channel disconnections (e.g., every second) from node mobility/channel perturbations. An optical design was used to sense ultra-weak retroreflected light and design a custom adaptive scanning algorithm (Algorithm 1) that (1) minimizes the tracking delay by separating initial acquisition from beam realignment, (2) exploits cross-medium refraction to increase scan coverage.

Algorithm 1: Adaptive Scanning.

| 1 | Initialization: scan flag = 1, connected = 0, time out = 0 | | | |
|---|---|---|---|---|
| 2 | while True do | | | |
| 3 | \| | if scan flag == true then | | |
| 4 | \| | \| | scan flag = false | |
| 5 | \| | \| | if connected == true/*connection established*/ then | |
| 6 | \| | \| | \| | if time out < threshold₂ then |
| 7 | \| | \| | \| | \| current state = realignment |
| 8 | \| | \| | \| | \| time out + + |
| 9 | \| | \| | \| | else |
| 10 | \| | \| | \| | \| current state = acquisition |
| 11 | \| | \| | else | |
| 12 | \| | \| | \| | current state = acquisition /*never detected*/ |

| 13 | \| | if unique frequency detected && magnitude > threshold₁ then | |
|---|---|---|---|
| 14 | \| | \| | connected = true /*found the robot*/ |
| 15 | \| | \| | decode backscattered data |
| 16 | \| | else | |
| 17 | \| | \| | scan flag = true /*robot not found, keep scanning*/ |
| 18 | \| | \| | connected = false |

Sensing with Optical Fiber Ring

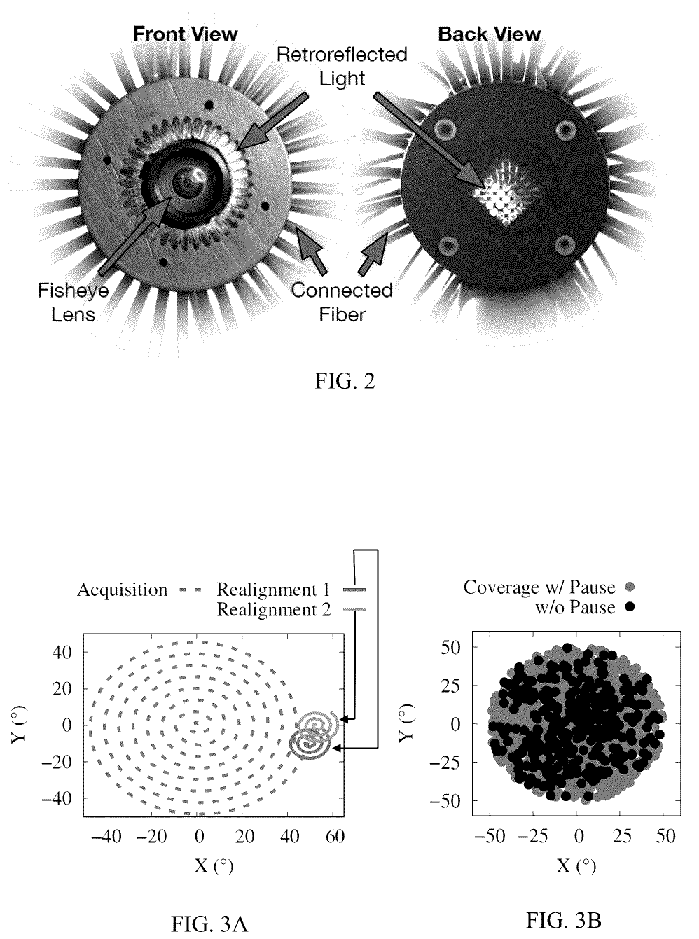

To handle weak retroreflected light, an embodiment of the present disclosure includes an optical design built upon an optical fiber sensing ring. As shown in FIG. 2, the sensing ring is composed of optical fiber bundles that are evenly placed around the transmitter's fisheye lens. Given the flexibility associated with optical fiber (e.g., minimum bend radius of 25 mm), the optical fiber can be collocated as close as possible to the transmitter's exit point, thereby maximizing the amount of backscattered light capable of being sensed. After the retroreflected light bounces back to the transmitter, it will illuminate the various optical fibers surrounding the transmitter's exit lens. The opposite end of the optical fibers are then diverted away from the transmitter's lens and combined to a single point, allowing the faint amount of retroreflected light to be aggregated to a single point. As a result, small, fast photodiodes (e.g., silicon photomultiplier sensors) can be coupled with small-core fiber for high gain and high-sensitivity sensing. The use of the fiber bundles expands the sensing area, resulting into aggregated light with higher energy density being projected to the small sensing area of a high-gain photodiode. This design helps to sustain sensing at meter-level distances.

The fiber ring design also addresses the challenges of collocating photodiodes with light source. When the retroreflected laser light arrives back at the transmitter, it will have travelled along nearly the same path as it took to arrive underwater. Consequently, a photodiode can be placed directly over the transmitting lens so that it can detect the majority of retroreflected light. Placing the photodiode to the side may limit the amount of retroreflected light that could be received and can result in receiver blind spots. Although these blind spots can be reduced with larger photodiodes strategically placed around the exit point, the increase in size may affect photodiode's sensitivity.

Adaptive Scanning

To minimize the scanning delay, scanning was split into two phases: acquisition and realignment. During the acquisition phase, calibration was performed once to get the environmental noise level for setting threshold₁ and then scan in an Archimedean spiral pattern which is commonly used in FSO. This pattern is useful for the acquisition stage as it can scan a large area in an efficient amount of time. After modifying the original spiral algorithm's step size to match the laser beam size, all points in the steering field-of-view (FOV) are guaranteed to be hit. Once the link has been acquired, there is a switch to the realignment scan pattern, which can be a modified version of the acquisition pattern that targets a smaller area immediately close to the last known position. This enables the system to quickly find the next surrounding position of the underwater node while also ensuring that the next position is not missed. Only when the underwater robot cannot be found after a certain amount of time (i.e., Algorithm 1 line 8: thresholds is set as the time duration for two full cycles of the realignment scan), the acquisition scan will be triggered again. FIG. 3A shows a complete scan pattern with two realignments in calm-water.

Exploiting Wave Dynamics

Furthermore, the movement of water waves was leveraged to increase the scanning coverage by delaying each scan point (i.e., pausing the scan for a certain amount of time at a fixed steering angle), thereby allowing the refracted beam to hit multiple underwater positions for a single outgoing angle. Since the queen component identifies a worker component by its unique tag frequencies, it must receive a certain amount of data before applying the Fast Fourier Transform (FFT). For example, if the lowest tag frequency is 500 Hz, the queen component may need at least 2 ms worth of data for the FFT. To validate this scanning methodology, the water's surface was simulated with a sinusoidal wave model that is widely used for synthesizing water waves. FIG. 3A demonstrates the acquisition scan pattern underwater without the presence of waves. As shown in FIG. 3B, after adding the water waves in, the coverage area decreases to 77.2% without pausing at each point. However, with a 2 ms pause, the coverage area remains above 91%.

Angle-of-Arrival Sensing

Once the laser beam hits the worker component, the next step is for the worker component to derive beam's incident angle. Given the inevitable presence of water dynamics, which makes it difficult to simply compute the refracted angle via Snell's law, the design disclosed herein proposes a pinhole AoA sensing mechanism that allows real-time, medium-independent localization. Existing AoA sensing techniques typically require an array of photodiodes, which are not suitable in this case since a large beam size is required to guarantee each photodiode is triggered. However, a large beam size would severely decrease the sensing SNR. In this example, a pinhole iris was combined with an image sensor to create a low-cost, fully integrated AoA sensing mechanism for laser light applications.

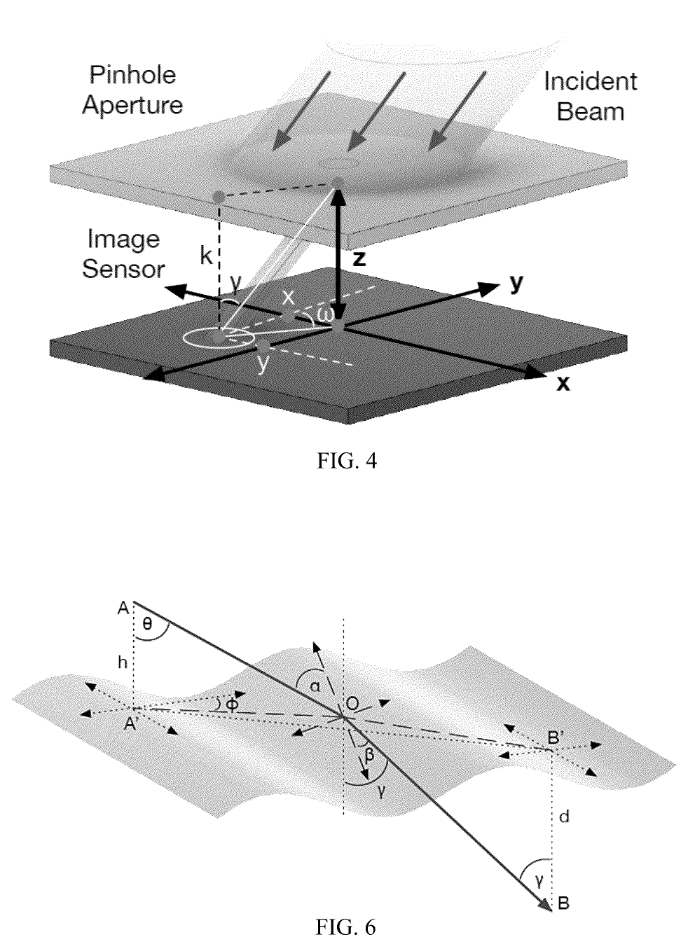

As shown in FIG. 4, by placing a small (e.g., 500 μm) pinhole mask above an image sensor with distance k, the laser beam produces a tiny spot, whose position is dependent on the incident angles γ and ω. Here, γ is the incident angle with respect to the vertical norm (i.e., the z axis) of the image plane, while ω is the angle with respect to they axis. Combining the location of the spot on the image sensor, (x, y), with height k, can derive γ and ω as:

$$γ = arc tan ( \frac{k}{\sqrt{{x}^{2} + {y}^{2}}} ) , ω = arc tan ( \frac{y}{x} ) \qquad ( 1 )$$

This application only requires γ to locate the underwater robot since ω only determines the robot's yaw angle, which in practice can be determined with an inertial measurement unit (IMU) installed on the robot. Additionally, the rotation angle ω can be useful for other applications (e.g., underwater robot attitude control and commanding specific directions).

Spot Location Detection

Since both ambient light and laser light will pass through the pinhole mask, a constant light spot will appear on the image sensor regardless of the presence of laser light. The addition of an optical bandpass filter can remove the influence of ambient light from the AoA sensor. However, optical bandpass filters are often limited to ≤5° incident angles (thereby limiting the sensing range). Instead, the laser light utilized in this example has a higher energy density than the sunlight, and reduced the image sensor's exposure time accordingly. Specifically, by reducing the exposure from several milliseconds (which causes both spot sizes to appear equal in size as the image sensor is saturated at these intensity levels) to several microseconds, the spot size corresponding to the laser light will be larger than the one corresponding to the ambient light. Therefore, a threshold was set to filter out the smaller of the two spots. Once the laser light spot was obtained, the next step was to derive its location on the image sensor. Since the beam size was much larger than the pinhole, the spot shape was the same as the pinhole (i.e., a circle). Thus, the center of the spot was used to represent its location. The actual center of the spot, (x,y), was computed by taking the average over the pixel coordinates whose intensity values are higher than the given threshold. After getting the distance (k) between the pinhole mask and the image sensor during calibration, the incident angles could be derived with Equation (1), regardless of the refractive index mismatch between the two mediums.

Laser-Optimized Backscatter

After AoA sensing, the worker component reuses the laser beam to send back the AoA results and its depth value (acquired by the robot's depth sensor) via a backscatter communication channel. The use of backscatter minimizes sensing delay and better supports constant water dynamics and link mobility. Existing light-based backscatter systems generally consider light-emitting diodes (LEDs) as light emitters and all rely on liquid crystal display (LCD) shutters to modulate the backscattered light. An LCD shutter can include of two orthogonal linear polarizer, one placed on each surface of a liquid crystal polymer. By applying a voltage to the liquid crystal, the twist state of the liquid crystal changes, either allowing the polarized light to pass through or be blocked. This design, however, entails energy loss when coupling with LEDs. Specifically, since light emitted from LEDs is inherently unpolarized, when it passes through the first linear polarizer, half of the energy is blocked.

The polarized nature of laser light was exploited to circumvent such energy loss and boost the energy efficiency of light-based backscatter communication. Specifically, since laser light is inherently linearly polarized, the first linear polarizer on the LCD shutter can be removed, thus increasing the efficiency from the conventional 50% up to 100% (essentially limited by the polarization percentage of the laser diode). However, since the linear polarization direction of the laser light changes as the emitter rotates, the incident light on the LCD shutter might be completely perpendicular to the second polarizer. Consequently, adopting a conventional light-based backscatter design directly with LDs would result in the amount of backscattered light to range from 0% to 100%, leading to instability and high error rates of demodulation.

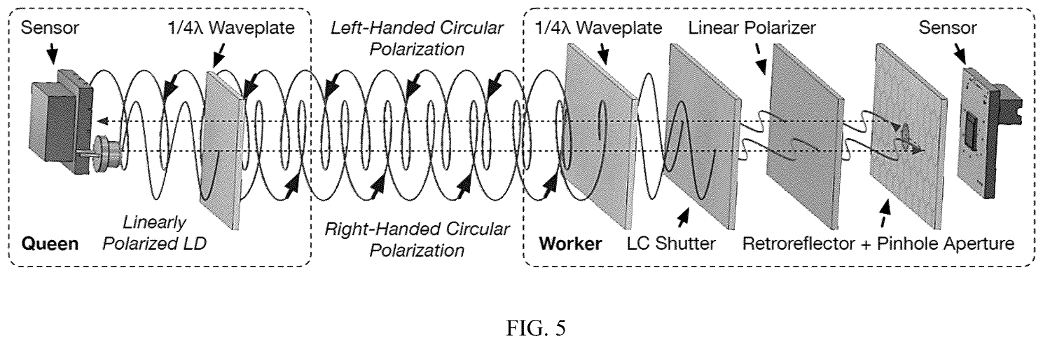

To maximize the retroreflected light energy regardless of the laser or shutter's orientation, this example utilizes a system design that converts linearly polarized light to circularly polarized light boosting the robustness against laser/shutter rotation. This conversion is achieved via a pair of quarter waveplates. As shown in FIG. 5, the first quarter waveplate was aligned with the laser diode such that the polarization direction of the laser light was 45° relative to the fast axes of the quarter waveplate. With this alignment, the linearly-polarized laser light becomes circularly-polarized, meaning the magnitude of polarization is constant along the axis of propagation. Similarly, on the underwater node, the second quarter waveplate's fast axis was aligned 45° relative to the polarization direction of the liquid crystal (LC) shutter in its open state. This transforms the circularly polarized laser light back to linearly polarized light and ensures that the polarization direction is parallel to the LC shutter when open. Then, changing the voltage of the LC shutter can pass or block up to 100% of the incident laser light from hitting the retroreflector. The relative rotation between the first and the second quarter wave-plate will not change the linear polarization direction before or after the transformation. Thus, once the polarization alignment on both nodes is fixed, the polarization direction of the laser light will be parallel to the backscatter node's LC shutter when open, and perpendicular when closed regardless of the relative movement between the aerial and underwater nodes.

Backscatter Modulation

Additionally, frequency-shift-keying (FSK) modulation can be applied for backscatter communication. FSK is more robust than other modulation schemes such as On-Off Keying (OOK), which relies on the single rise of light intensity to encode data and can be falsely triggered by ambient light variations or reflection from other surfaces. With FSK, high frequencies (e.g., above 500 Hz) were chosen that are not common in the environment to avoid the false triggering from ambient light. To deal with the rare cases where ambient noise sources have frequencies close to the frequencies chosen for FSK implementation, an initial calibration step was added that collects one-second of ambient light data (with the laser off) and computes the maximum energy magnitude at the frequencies of interest. This magnitude is then set as the threshold for detecting the backscatter tag. A voting-based frequency determination procedure coupled with a sliding window in the decoding scheme was also added. Specifically, the received data was first synchronized by correlation analysis of the preamble. Then a sliding window was used to loop through the synchronized data and take the mode of all the dominant frequency elements of each trial as the final dominant frequency for each bit. Thus, the decoding is more robust to imperfect synchronization caused by noise.

Computing Robot Location

After receiving the depth and AoA information from the backscatter channel, the queen component can combine them with the laser's steering angle and its altitude to compute the precise location of the underwater worker components. As shown in FIG. 6, an aerial drone (A) is h meters above the water's surface, communicating with an underwater robot (B), which is d meters below the water's surface. In order to locate the underwater robot, the distance between A′B′ (d_{A′B′}) must be known, and the azimuth angle ϕ. A′ and B′ are the vertical projections of A and B onto the flat water surface and O′ is the incident point. If A′ is set as the origin of the coordinate system, the coordinate of the underwater robot relative to the aerial drone can then be derived from:

(X,Y)=d_{A′B′}*(cos ϕ), sin ϕ). (2)

d_{A′B′} can be further divided into d_{A′O} and d_{O′B}. D_{A′O} can be computed from the height of the drone (h), and the elevation angle (θ) of the laser scanning, where h, θ (together with ϕ) are provided by the drone's altitude sensor and the laser beam steering controller. Computing the second distance (d_{OB′}), requires the depth of the underwater robot (d) and the angle between the vertical line and the refraction line (γ). If the water was a flat surface, the incident angle from the air to the water (α) would be the same as the elevation angle (θ), and the refraction angle (β) would be the same as γ. Then, using Snell's law, γ could be derived. However, as stated above, γ≠β due to wave dynamics. One potential solution is to sense and model the water's surface in real time and find out the normal plane of the incident point. Unfortunately, this is difficult to deploy. Additionally, although the refractive index of the water (which is necessary for deriving γ) can be measured with a refractometer, they typically cannot be interfaced with a microcontroller (MCU). Thus, instead of using Snell's law, the angle of arrival (y) was sensed with the pinhole design on the receiver side. The coordinates of the underwater robot then become:

(X,Y)=[h tan θ+d tan γ]*(cos ϕ, sin ϕ). (3)

This geometry relationship is satisfied with the assumption that A′ and B′ are on the same plane, which means the measurement of h and d should be relative to a flat water surface.

Queen Component

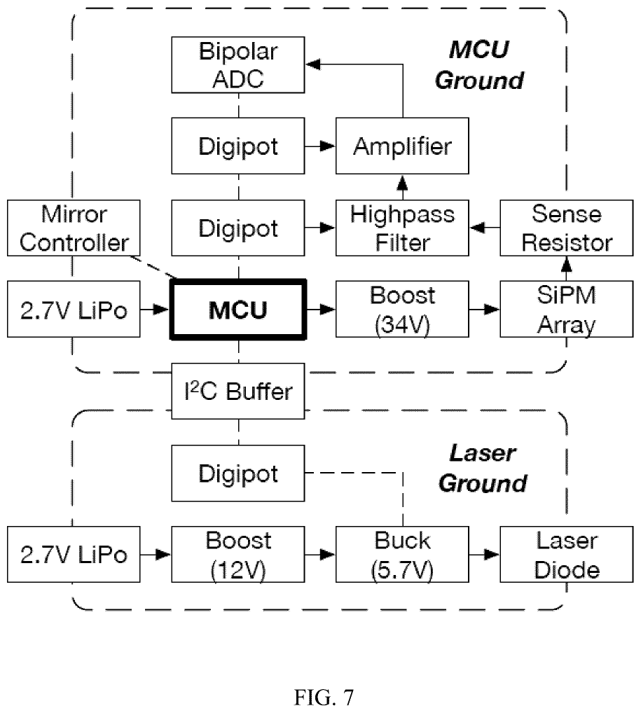

The queen component's laser is configured as a continuous wave (CW) to reduce system complexity. As shown in FIG. 7, the queen component utilizes a simple constant-voltage driver circuit capable of supplying up to 1 A of current to the laser diode. The laser power is supplied by a 10050 mAh 3.7 V lithium-polymer (LIPO) battery, boosted to 10 V using a switching voltage regulator, then linearly regulated down to the laser's operating voltage using an LM317. The laser voltage is electronically controlled by an I²C digital potentiometer, allowing mV-resolution adjustments from a single MCU (Teensy 4.0). To reduce noise, the laser driver resides on a separate ground plane than the other digital components, and communicates with the MCU using general-purpose input/output (GPIO) and I²C isolation buffers.

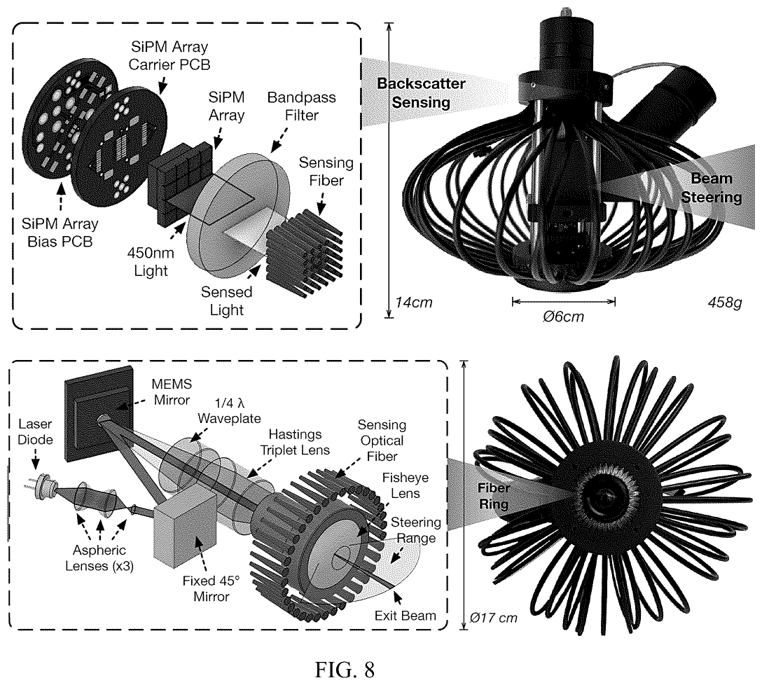

The wide-angle beam steering is achieved with a custom optical circuit design (FIG. 8 (right)). Aside from the micro-electromechanical systems (MEMS) mirror, the other optical components are all passive. The queen component's laser diode (LD) (450 nm, Osram PLT5450B) is collimated using a single aspheric lens with a focal length (2.76 mm) large enough to place the lens at the LD's focal point. The beam is then converged to a single point with an equivalent aspheric lens and oriented 180°. A short focal length aspheric lens is placed at this focal point, allowing the originally large collimated beam diameter (5 mm) to be reduced to a smaller collimated beam diameter (2 mm) suitable for the remaining optical elements.

The collimated beam is then coupled to a 3D printed mount, reflecting the beam off of a fixed-angle mirror and onto the MEMS mirror with an angle-of-incidence (AoI) of 22°. The MEMS mirror is connected to a Mirrorcle USB-SL MZ controller which is controlled by the MCU using a USB serial interface. After reflecting off the MEMS mirror, the steered beam passes through an infinite conjugate ratio triplet lens to focus the outgoing beam and correct the AoI for the remaining optical elements. Then a quarter waveplate is positioned in a rotation mount just after the triplet lens. The quarter waveplate is aligned 45° relative to the laser's measured polarization direction (98% polarized) and converts the light to circularly polarized (confirmed with a polarimeter). Finally, the circularly polarized light passes through a fisheye lens for an expanded steering range. The position between the triplet lens and the fisheye lens dictates the divergence of the outgoing beam and is experimentally fixed to provide optimal beam quality.

The backscatter receiver is another component of the queen component implementation. FIG. 8 (left) shows the exploded view of the optical fiber ring. The diverted light passes through an optical bandpass filter tuned to the wavelength of the queen component's laser. After passing through the filter, the monochromatic light is free-space-coupled to an extremely high gain 4×4 silicon photomultiplier (SiPM) array matched to the size of the exit fiber bundle. A custom PCB treats all SiPM array elements as parallel current sources, biased to 32 V using a switching voltage regulator on a separate PCB. The current is then converted to a voltage with a variable resistor, and fed over an SMA cable to the backscatter receiver.

A PCB for the backscatter receiver (FIG. 7) was fabricated. It first AC-couples the SiPM voltage with a fixed capacitor and digital potentiometer, allowing the waveform to be electronically tuned by the MCU. The filtered signal then passes through an impedance matching buffer that also amplifies the signal using another digital potentiometer (allowing electronically adjusted gain). Since the signal is now AC-coupled, the bipolar signal is sent through a bipolar ADC that connects to the MCU over serial peripheral interface (SPI). FSK demodulation and localization logic was implemented using C/C++. The ADC sampling rate was set to 16 kHz with a symbol duration of 2 ms, resulting in an FFT frequency resolution of 500 Hz. As mentioned above, a sliding window decoding strategy with window size 32 and step size of 1 was implemented. Through experimentation, Reed-Solomon coding was utilized to correct up to 3 incorrect bits, reserving 24 bits for data and 6 bits for parity.

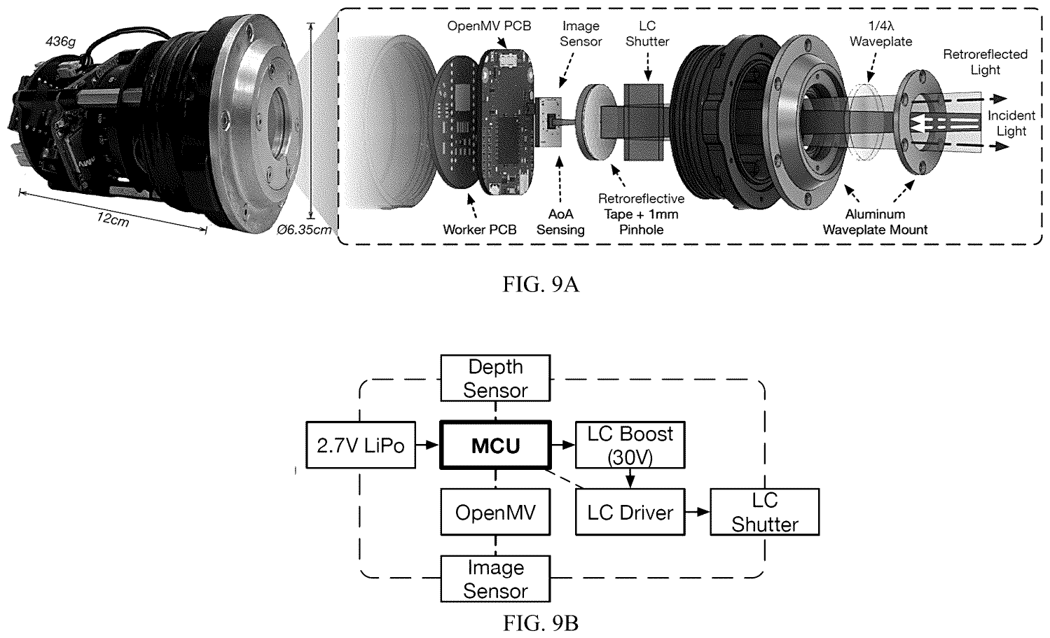

The worker component implementation contains following modules: (1) Worker Optical Circuit and (2) Worker Controller and Waterproof Enclosure. FIG. 9A shows the connection of all hardware components on the worker component. To minimize the effects of refraction, the quarter waveplate directly contacts water, sealed between two O-rings and airtight coupled to the underwater enclosure with a custom milled aluminum cap. Directly below the quarter waveplate is a Bolder Vision liquid crystal PiCell shutter, capable of changing its linear polarization state up to a few kilohertz. Since the incident light is now linearly polarized 45° relative to the fast-axis of the quarter waveplate, the shutter is oriented so its linear polarization is 45° relative to the quarter waveplate's fast axis. The shutter is controlled electronically by the worker component's MCU for backscatter modulation. The FSK modulation logic runs on the Teensy 4.0 with an implementation in C/C++. The synchronization/two data frequencies was set to 500 Hz, 1 kHz and 2 kHz, respectively.

The AoA sensing apparatus is then placed directly below the retroreflector. Specifically, retroreflective tape was placed atop a 500 μm diameter pinhole (Thorlabs P500K). An OpenMV image sensor lies directly below the pinhole's aperture, connected via a ribbon cable to the main OpenMV controller. The MicroPython libraries for blob detection was leveraged and the pixel coordinates of the laser spot was sent to the worker component's MCU over a serial connection.

FIG. 9B shows the circuitry of the worker component PCB. To drive the PiCell shutter, a Microchip HV508 driver is coupled with a simple switching voltage boost regulator to achieve the correct drive voltage and pulse frequency (i.e., 100 kHz square wave alternating between 3.3 V and 30 V depending on the shutter's state). The OpenMV is connected via SPI to the worker component's MCU, and its PCB is shaved down to fit within the 2 inch waterproof enclosure. The waterproof enclosure is a 2 inch diameter aluminum tube with a custom USB cable and a Bar02 pressure sensor to provide depth measurements for the localization algorithm. A USB PCB is soldered to provide remote USB, GPIO, and reset access to the internal controller during experiments.

The localization accuracy, range, and robustness of an embodiment of the present disclosure was evaluated in a variety of scenarios.

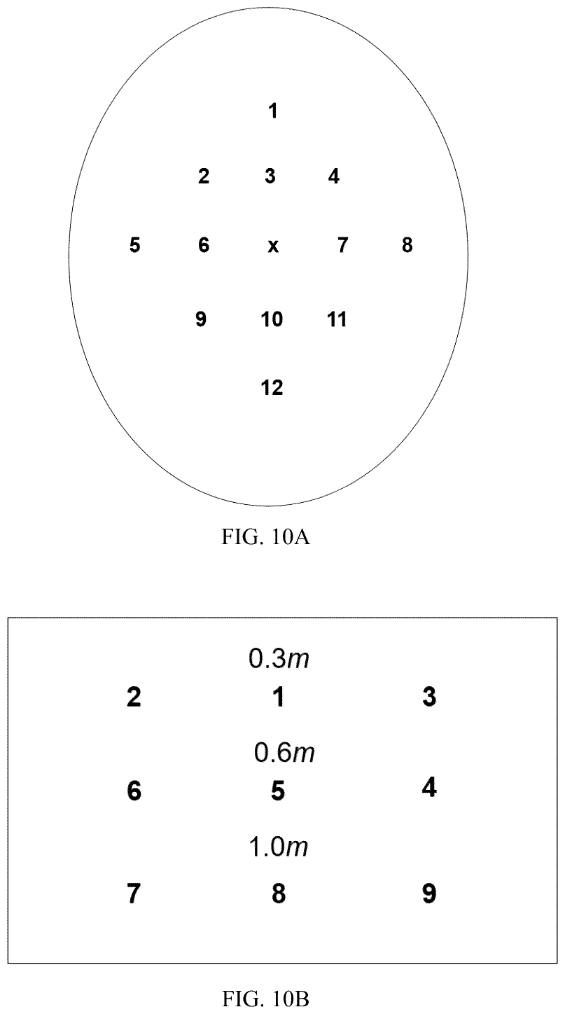

The accuracy of the localization methodology was examined in two setups: (1) a large water tank (1.6 m×1.75 m×0.63 m) filled with chlorine water (FIG. 10A) and (2) an indoor swimming pool (7 m×25 m×1 m to 3 m) (FIG. 10B). The illuminance was approximately 500 lx throughout the water tank experiments, and 1500 lx throughout the pool experiments. Since all experiments were performed indoors—precluding the use of GPS—the queen component remained fixed in the air rather than attached to a mobile drone. The two baselines were compared to the accuracy of an embodiment of the present disclosure: the single-medium sensing case (i.e., without the presence of water) and the cross-medium sensing case (i.e., with water but not using the worker component's sensed AoA).

Experiments were performed with a calm water surface. A controlled water environment to manually provide the ground truth with known accuracy was considered. To provide the most accurate ground truth, twelve locations uniformly spread on the bottom of a large water tank were manually marked (FIG. 10A). Each location was 25.4 cm apart from adjacent locations. The queen component was fixed to a tripod 1.65 m in the air (maximum height to the ceiling) and placed at the center of the tank, looking downwards. For each of the twelve locations, the worker component was placed so the plane of its quarter waveplate was parallel with the plane of the queen component.

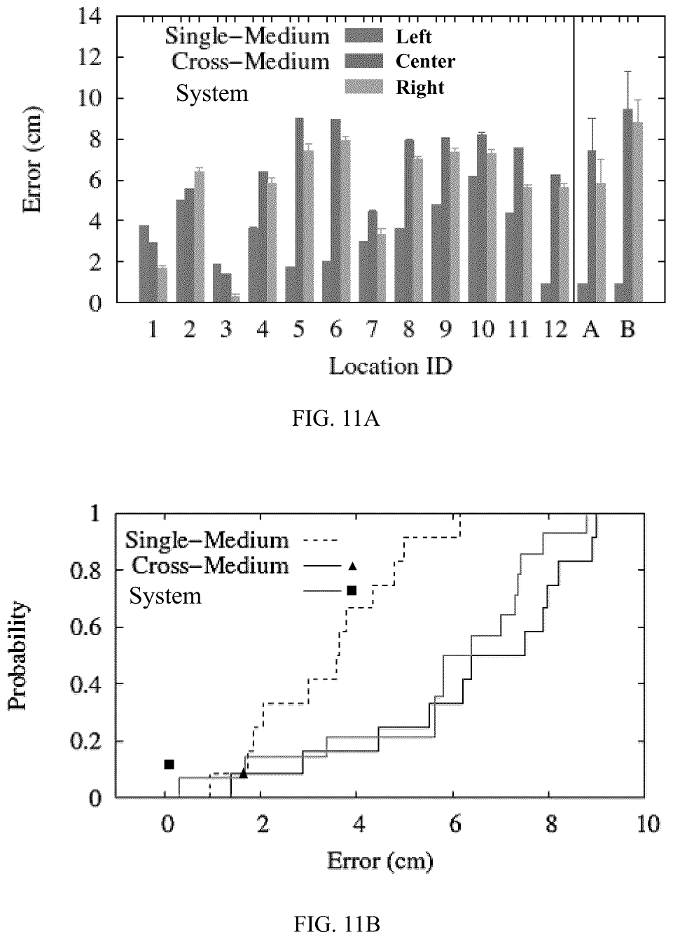

To first confirm the single-medium accuracy, the worker component was placed at each marked location before filling the tank with water. As shown in FIG. 11A, the localization error was plotted for each ground truth location, defining the error as the Euclidean distance between the derived worker component locations and the ground truth locations. For each location, 100 position samples were collected by the queen component and averaged, with error bars showing the standard deviation per point. Across all points, the average single-medium localization accuracy of the system was 3.4 cm with a standard deviation of 1.5 cm.

Next, water was added to evaluate the cross-medium accuracy and the accuracy of an embodiment of the present disclosure. First, the water tank was filled with 30 cm of water, effectively placing the worker component 15 cm from the air-water interface and at 1.5 m distance to the queen component. Second, the above error calculations were repeated for each point in the presence of calm water. Notably, across all points, the average cross-medium localization offset of the system was 6.4 cm with a standard deviation of 2.5 cm. Adding in the design of an embodiment of the system of the present disclosure, an average localization error of cm with a standard deviation of 2.4 cm could be achieved—corresponding to 3.6% (error) and 1.6% (STD) of the total distance between the queen component and the worker component (1.5 m). FIG. 11B compares the distribution of location errors. The difference between the cross-medium baseline and the system performance is small in this experiment as the depth of the water was only 15 cm, limiting the influence of refraction.

Experiments were performed when the depth was increased. Having established the low-error and high-stability of the system, the impact of deeper water depths that were impossible to achieve in the water tank were tested. The queen component was fixed to a tripod 1.65 m in the air and placed at the edge of the pool (FIG. 10B). Since manual ground truth measurements were prone to human-error in a large-scale pool setting, a fiducial marker was used in a known position to localize an AUV with the worker component. Fiducial markers are commonly used as ground truth measurements of relative positions at close ranges in underwater environments. Specifically, the AUV utilizes a proportional-integral-derivative (PID) controller to maintain a stable position underwater by sampling the fiducial marker with its monocular camera and making small corrections over time with a stability of approximately 10 cm. Location measurements provided by fiducial markers underwater have been shown to be Gaussian distributed with mean near ground truth. As a result of the AUV's position corrections and water flow through the pool drain, approximately 2 cm waves were present on the surface of the pool. The worker component was attached to the AUV and the AUV was steered to nine predefined locations as shown in FIG. 10B, with depths of 0.3 m, 0.6 m, and 1.0 m.

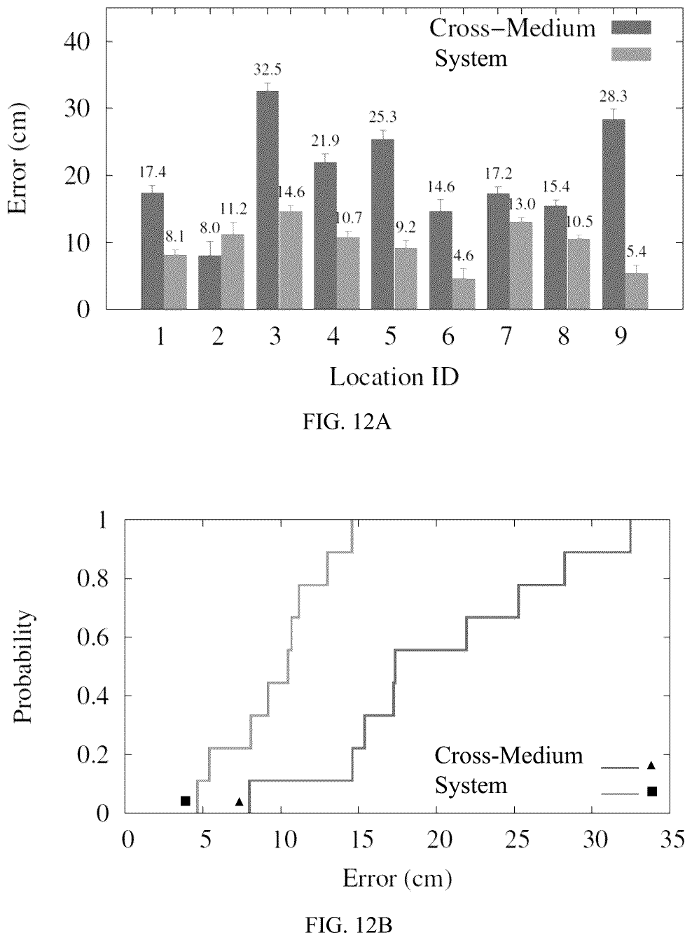

As shown in FIG. 12A, the average localization error across all nine positions without the AoA sensing component was 20.1 cm, with a standard deviation of 2.1 cm. After adding the AoA sensing in, the system achieved a localization error of 9.7 cm with a standard deviation of 4.5 cm—corresponding to 3.4% (error) and 0.2% (STD) of the total distance between the queen component and the worker component (2.8 m). FIG. 12B further illustrates the improvement of an embodiment of the system of the present disclosure over the baseline without AoA sensing. This performance of the system was consistent with the tank experiments, and validated that the AoA sensing component is essential when dealing with deeper water depths.

Furthermore, due to environmental noise and the current caused by the pool drain which physically moved the AUV, the AUV was constantly adjusting its position at each of the nine target locations. Despite this effect, the queen component was able to maintain contact with the worker component 90% of the time (on average) after the initial acquisition, benefiting from the beam realignment scheme outlined above. This validates that the system is robust to disturbances affecting the station-keeping of AUVs that is especially present in shallow waters.

The results were compared to other systems. The reported accuracy of a commercially-available “underwater GPS,” based on a short baseline acoustic (SBL) positioning system composed of four transducers at the surface and one on the underwater robot is 1% of distance between the transceiver and the object. This ideal value is comparable with the system accuracy of the embodiments disclosed herein. In practice, many factors affect the real-world accuracy of any acoustic positioning system, including errors in the geometric configuration of the transducers and of the utilized sound profile. For example, an ultra-short baseline (USBL) system has frequent location jumps within a few meters. In comparison, the system provides significantly greater localization accuracy without meter-level jumps. Additionally, none of the previous systems are capable of cross-medium sensing, as acoustic signals cannot pass through the air-water boundary.

Experiments were performed on a dynamic water surface. The accuracy of the system in the presence of waves was investigated. To ensure that the ground truth measurement was accurate, the worker component was placed at location twelve (FIG. 10A), which has the lowest single-medium error (and therefore highest ground-truth accuracy). Furthermore, location twelve was chosen to be farthest from the center of the tank, thereby ensuring a longer transmission distance and non-zero incident/retroreflected angle. Two wave conditions were manually generated by a rigid panel: wave A having an approximate peak-to-peak amplitude of cm and wave B having an approximate peak-to-peak amplitude of 20 cm. As shown in FIG. 11A, wave A caused an average localization error of 5.8 cm±1.23 cm and wave B caused an average localization error of 8.8 cm±1.12 cm. Given the range of waves typically found in nature (e.g., 2 cm to 20 cm), the system is still applicable with this level of wave dynamics. A variety of other wave conditions were analyzed using a theoretical analysis disclosed below.

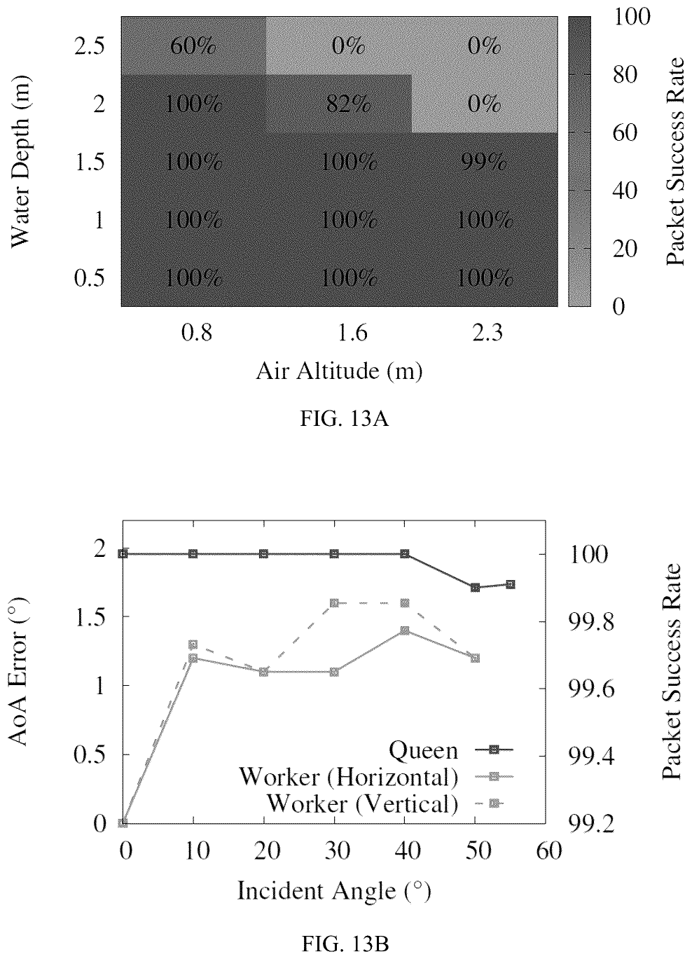

The sensing range was analyzed. Having demonstrated the localization accuracy of the system, next the maximum sensing range that can be supported was explored. Since sensing inherently relies on the correct reception of backscattered packets, the maximum range was defined according to the packet-level correctness of the communication channel. In other words, if a packet containing crucial localization information could be correctly decoded, then sensing at this range was achievable. Consequently, the sensing range could be written in terms of the packet success rate, i.e., (1−PER)×100 where PER is the packet error rate after Reed-Solomon (RS) coding. In the same pool environment, the worker component was attached to an underwater tripod and the queen component to a tripod on the edge of the pool. For each position of the worker component, the tripod was raised/lowered to three different distances spanning 0.8 m to 2.3 m. By slowly moving the worker component along the bottom of the pool, the depth was increased from 0.5 m to 2.5 m. As shown in FIG. 13A, a packet success rate of 100% was achieved in most transmission scenarios, including an over 99% packet success rate up to a 3.8 m air-water distance (2.3 m air, 1.5 m water), which is sufficient for many underwater robot applications. Finally, it was determined that the total laser propagation distance was twice the physical queen/worker component distance due to the backscatter communication channel.

Additionally the angular sensing range of the queen component and worker component was evaluated. To measure the angular range of the worker component, the worker component was rotated both vertically and horizontally so that the incident angle changes until the center of the beam spot reaches the two edges of the image sensor. As shown in FIG. 13B, the worker component can support AoA sensing between −50° and 50° on both axes. Furthermore, the AoA sensing error was stable across the whole sensing range with an average error of only 1.2°. To measure the angular range of the queen component, the worker component was rotated to various fixed angles to have it transmitted to a fixed payload. The angular sensing range was quantified according to the packet success rate. As shown in FIG. 13B, the packet success rate was over 99% for the entire optical steering range (i.e., −55° to 55°).

Next, the robustness of the system to common practical factors and its overall power consumption was evaluated.

Because it is impractical to physically generate and recreate waves with predefined parameters, the impact of wave dynamics was investigated on the localization accuracy with a theoretical analysis. As disclosed above, wave dynamics will cause an offset between the measured height to the drone/depth to the underwater robot and the desired distance to the incident point on the water. Specifically, the amplitude of the wave will directly influence the localization error while the wavelength and frequency of the wave will determine the rate at which the highest error occurs.

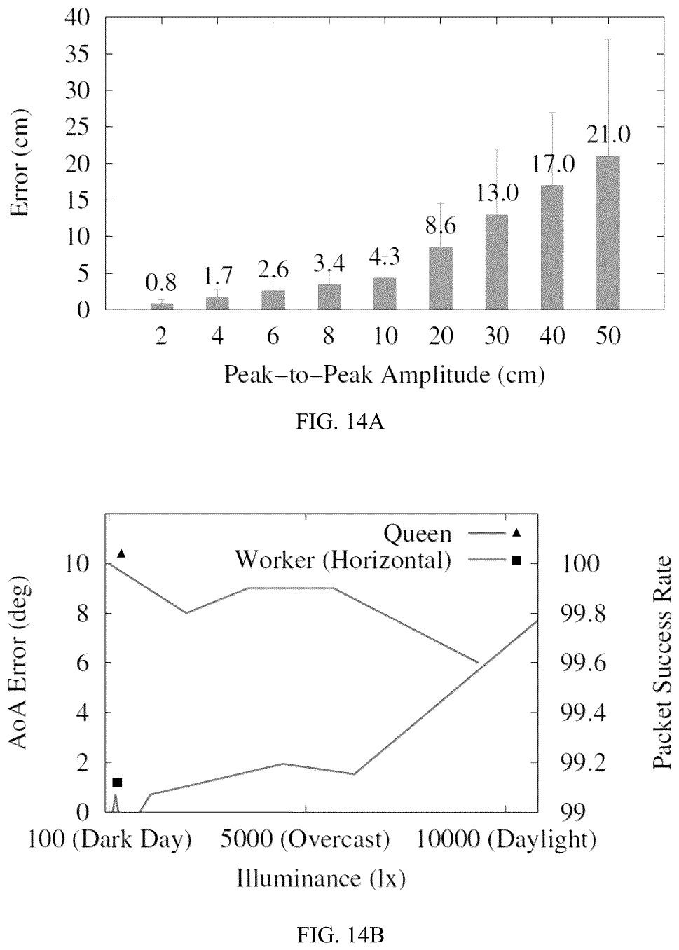

In the theoretical analysis, the peak-to-peak wave amplitude was varied to simulate the impact of the range offset. At each wave amplitude, the localization error was computed from all possible incident angles (0° to 55°) and average errors. As shown in FIG. 14A, the localization errors were all below 10 cm when the peak-to-peak amplitude was smaller than meter (a value typical for lakes). With larger amplitudes of 0.5 m, the localization errors caused by the range offset were still below 20 cm. Notably, this error was independent of the actual height of the drone and depth of the worker component. The systematic error could be removed, as discussed below.

Next the impact of different ambient light conditions on both the queen component and worker component was evaluated. The distance between the queen component and the worker component was fixed to 1 m in the air and each component was illuminated separately with a white LED (generated from a 490 nm LED plus yellow phosphor) of various intensities. First, the queen component was illuminated and the packet success rate was measured. As shown in FIG. 14B, the queen component was able to achieve a >99% packet success rate above 10 klx (corresponding to a sunny day). This demonstrates that the optical design is robust to strong ambient light, benefiting from the narrow spectral filtering of the queen component's bandpass filter that is tuned to its laser's wavelength.

Next, the LED was placed at 50° relative to the worker component and the queen component was connected with a 5° incident angle. The worker component was attached to a Thorlabs rotational platform and rotated from 0° to 50°, comparing the AoA results with the readings from the rotational platform. FIG. 14B shows that the derived AoA errors are within 2° up until the light intensity is increased to 6220 lx (a moderately sunny day). Above 10 klx, the AoA error is 7.7°. A potential reason is that this LED intensity is comparable to the laser, causing the center of the spot on the image sensor to deviate.

The power consumption of the queen component and the worker component was also examined (Table 1). Overall, each component consumes roughly 2 W. Comparing to the commercially-available systems which consume around 27 W, the system disclosed herein consumes 84% less power at only 4.3 W. Furthermore, various components can be optimized to reduce the overall system power. For example, low-power MCUs can be utilized if a 600 MHz clock rate is not essential for the application scenario. Furthermore, lower-power or higher-efficiency laser diodes can be considered depending on the required sensing range. On the worker component, a low-power image sensor/processor can replace the OpenMV that is currently utilized. Finally, alternatives to the LC driver/shutter can be considered, such as free-space electro-optic modulators that can also alter the laser polarization state.

TABLE 1
Power consumption of the queen component
and the worker component

| Queen | Power (mW) | Worker | Power (mW) |
|---|---|---|---|
| MCU | 500 | MCU | 500 |
| MEMS Mirror | 500 | AoA Sensing | 528 |
| SiPM Array | 150 | LC Driver | 700 |
| ADC | 20 | LC Shutter (On) | 450 |
| Laser Diode | 975 | | |
| Queen Total | 2145 | Worker Total | 2178 |

Proactive Wave Sensing

The major source of localization error in the presence of large-amplitude waves is a single, one-dimensional height measurement in the air and underwater. Since this measurement can be out of phase with the water wave at the incident point on the surface, the resulting geometry will have an offset. One potential solution is to employ an array of ultrasonic distance sensors to model the wave in real time. Another option is to reduce the size of the ultrasonic array and leverage historical data of ultrasonic readings. Specifically, one ultrasonic sensor can be used to estimate the wave amplitude and frequency within a sufficiently small time window. Adding another ultrasonic sensor at a known spatial location would then allow the speed of the wave to be established, providing a snapshot of the wave at any given point in time.

Robot Tracking

Although the current implementation of an embodiment of the present disclosure can support discrete tracking of an underwater robot, continuous tracking requires algorithmic and hardware improvement. Algorithmically, historical sensing data could be utilized by the queen component to predict the underwater robot's next position based on movement continuity. Subsequent scans could then focus on the sector in the predicted direction to speed up the tracking rate. As for hardware improvements, optical beam steering needs microradian adjustments at fast rates to cover an entire scanning region before the robot moves too far away. Furthermore, the queen component and the worker component can use higher FSK frequencies to shorten the FFT window. Finally, the tracking speed can also benefit from faster communication of the backscatter channel, which is currently limited by millisecond rise/fall times of off-the-shelf LC shutters. Free-space electro-optic modulators can instead be utilized to alter the polarization state of light at rates up to tens of GHz.

Path Blockage Avoidance

Light-based sensing and communication requires line-of-sight propagation. Any opaque objects (e.g., suspended sediment) along the path will block light signals, causing the link to become unavailable. However, since a dynamic water surface might refract the laser beam differently depending on the incident point, alternative beam paths may exist that avoid the blockage. These alternative paths would need to be tested quickly, requiring the above improvements to scanning/sensing speed. Furthermore, aerial drones and underwater robots can exploit their mobility to avoid blockages by moving probabilistically if the connection is lost for a certain amount of time.

Tracking Multiple Robots

Embodiments disclosed herein may track multiple robots underwater. The FSK modulation of the backscatter communication can be used to support multiple underwater worker components. Specifically, a unique set of frequencies can be assigned to individual worker components, allowing the queen component to determine the worker component's identity while demodulating the backscattered signal.

Integrating Downlink Communication

In an embodiment, the queen component's laser beam can be modulated to provide data to the underwater worker component. To demodulate the queen component's data, the worker can collocate a photodiode with its AoA sensor. Finally, the worker component can continue to modulate the backscattered signal with FSK, allowing the queen component to separate its original amplitude modulation from the worker' components orthogonal frequency modulation.

As demonstrated in this Example, direct air-water sensing can be enabled using laser light between an aerial drone and an underwater robot. The implemented prototypes described herein were built with hardware and PCBs. Real-world experiments showed the robustness and accuracy of an embodiment of the present disclosure in the presence of waves, making the system and method a foundational technology for locating underwater robots from the air and enabling autonomous aquatic applications.

Although the present disclosure has been described with respect to one or more particular embodiments, it will be understood that other embodiments of the present disclosure may be made without departing from the scope of the present disclosure. Hence, the present disclosure is deemed limited only by the appended claims and the reasonable interpretation thereof.

1. A system comprising:
an aerial drone with a queen component disposed thereon, wherein the queen component is in electrical communication with the aerial drone; and
an underwater robot with a worker component disposed thereon, wherein the worker component is in electrical communication with the underwater robot;
wherein the queen component is configured to steer a laser beam to locate and track the worker component; and
wherein the queen component is configured to sense light from the laser beam reflected by the worker component.

2. The system of claim 1, wherein the queen component comprises a laser steering component and a sensing component.

3. The system of claim 1, wherein the worker component comprises an angle-of-arrival sensing component and a retroreflective tag.

4. The system of claim 1, wherein a scan point of the laser beam is delayed thereby enabling the laser beam to hit a plurality of underwater positions for a single outgoing angle.

5. The system of claim 1, wherein the system further includes a pinhole-based sensing mechanism.

6. The system of claim 1, wherein the system further includes an optical fiber sensing ring.

7. The system of claim 1, wherein the system further includes a backscatter communication design configured to maximize retroreflected energy.

8. The system of claim 1, wherein the queen component is configured to determine a position of the underwater robot in water using the aerial drone in air.

9. The system of claim 8, wherein the position is determined using a GPS location and altitude sensor reading of the aerial drone.

10. The system of claim 1, wherein the laser beam is generated by a blue/green laser.

11. A method comprising:
deploying an aerial drone with a queen component disposed thereon in a first medium; and
determining a location of a robot in a second medium with a worker component disposed thereon, using the aerial drone, wherein the second medium is different from the first medium.

12. The method of claim 11, wherein the first medium is air and the second medium is water.

13. The method of claim 11, wherein the queen component is configured to steer a laser beam to locate and track the worker component.

14. The method of claim 13, wherein the queen component is further configured to sense light from the laser beam reflected by the worker component.

15. The method of claim 13, wherein the worker component includes a retroreflective tag.

16. The method of claim 13, where a scan point of the laser beam is delayed thereby enabling the laser beam to hit a plurality of positions in the second medium for a single outgoing angle.

17. The method of claim 13, wherein the laser beam is generated by a blue/green laser.

18. The method of claim 13, wherein the laser beam has a wavelength range configured to minimize attenuation in the first medium and the second medium.

19. The method of claim 13, wherein the determining further includes:
sensing an incident angle of the worker component;
sending angle-of-arrival data and depth data of the worker component from the worker component to the queen component via backscatter communication; and
determining a location of the worker component in real time using the angle-of-arrival data, the depth data, a GPS location of the queen component, and altitude of the queen component.

20. A non-transitory computer readable medium storing a program configured to instruct a processor to execute the determining step in the method of claim 11.
